(19) United States
(12) Patent Application Publication
(10) Pub. No.: US 2004/0118264 A1
(43) Pub. Date: Jun. 24, 2004

(54) Machine for indenting (damaging) the surface of optical discs

(76) Inventor: Hsin-Chu Chen, Taipei (TW)

Correspondence Address: Hsin-Chu Chen, PO Box 82-144, TAIPEI, TW

(21) Appl. No.: 10/326,991

(22) Filed: Dec. 24, 2002

(51) Int. Cl. B26F 1/24

(52) U.S. Cl. 83/867

(57) ABSTRACT

A machine for indenting surface of optical discs includes a housing having a slot, two panels mounted within the housing, two rollers rotatably mounted between the two panels and provided with a plurality of protuberances thereon, a set of gears mounted on an outer side of one of the rollers and drivingly connected with the rollers, a motor drivingly connected with the gears, a control circuit electrically connected with the motor, and at least a sensor electrically connected with the control circuit and mounted close to the slot.

### BACKGROUND OF THE INVENTION

1. Field of the Invention

This invention is related to a machine for indenting (damaging) the surface of optical discs.

2. Description of the Prior Art

With the progress in scientific technology, the traditional way to use paper to record data has been replaced with optical discs, due to the popularity of the computer. When desired to destroy the information recorded in paper the conventional way is to use a paper shredder to break the paper into pieces. However, this kind of machine cannot be used to remove the data stored in optical disks. Hence, the conventional way to damage the data stored in optical discs is to make scars manually or by a special machine, but this is time-consuming, and requires a lot of money. Therefore, it is an object of the present invention to provide an apparatus which can damage the surface of optical discs quickly and efficiently.

### SUMMARY OF THE INVENTION

This invention is related to a machine for indenting (damaging) the surface of optical discs.

It is the primary object of the present invention to provide a machine for indenting surface of optical discs includes a housing having a slot, two panels mounted within the housing, two rollers rotatably mounted between the two panels and provided with a plurality of protuberances thereon, a set of gears mounted on an outer side of one of the rollers and drivingly connected with the rollers, a motor drivingly connected with the gears, a control circuit electrically connected with the motor, and at least a sensor electrically connected with the control circuit and mounted close to the slot.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the present invention.

FIG. 2 is a perspective view of the present invention.

FIG. 3 is a sectional view of the present invention.

FIG. 4 is another sectional view of the present invention.

FIG. 4A is an enlarged view of a portion of FIG. 4.

FIG. 5 is another sectional view of the present invention.

FIG. 5A is an enlarged view of a portion of FIG. 5.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

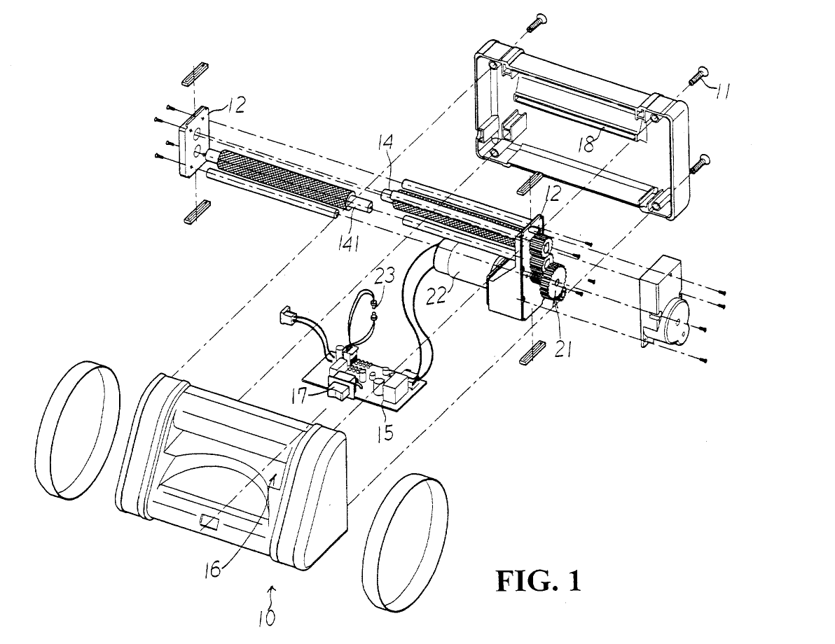

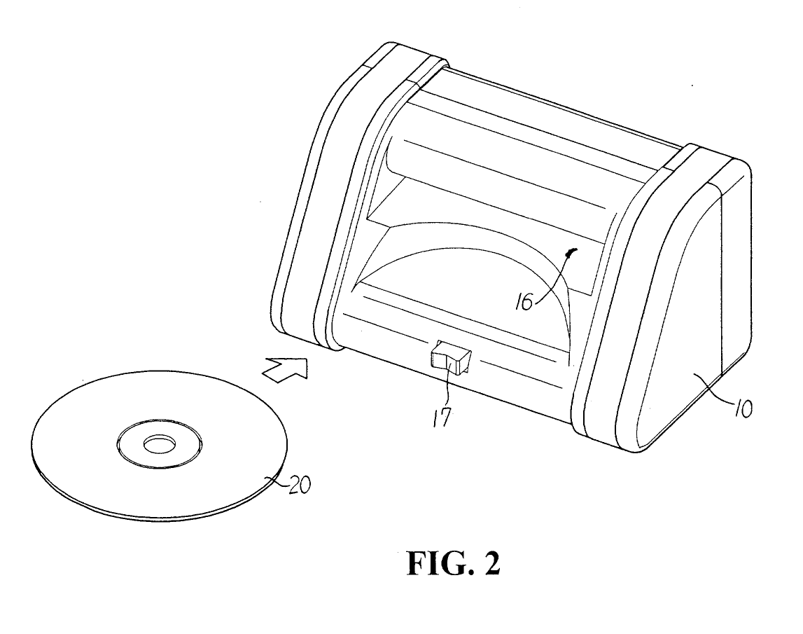

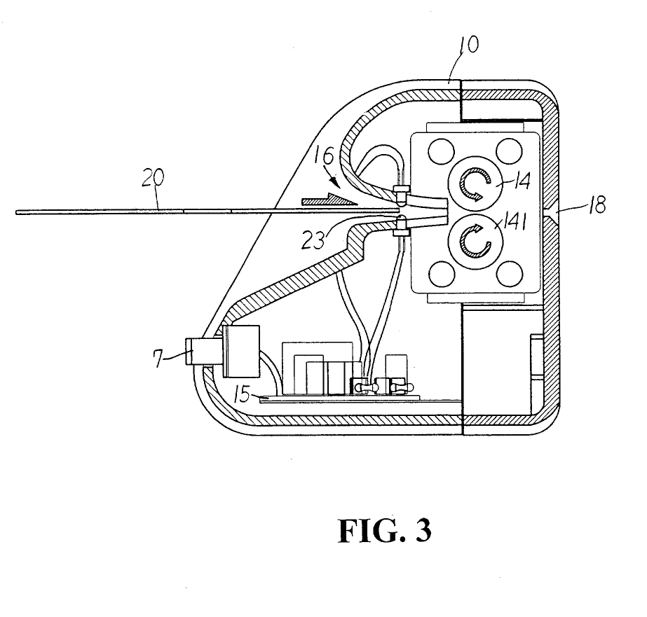

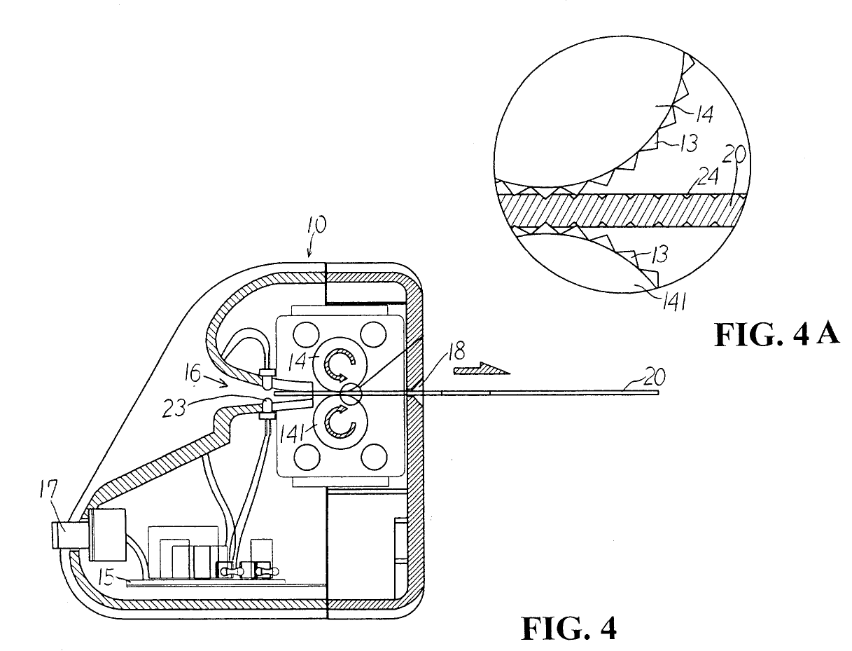

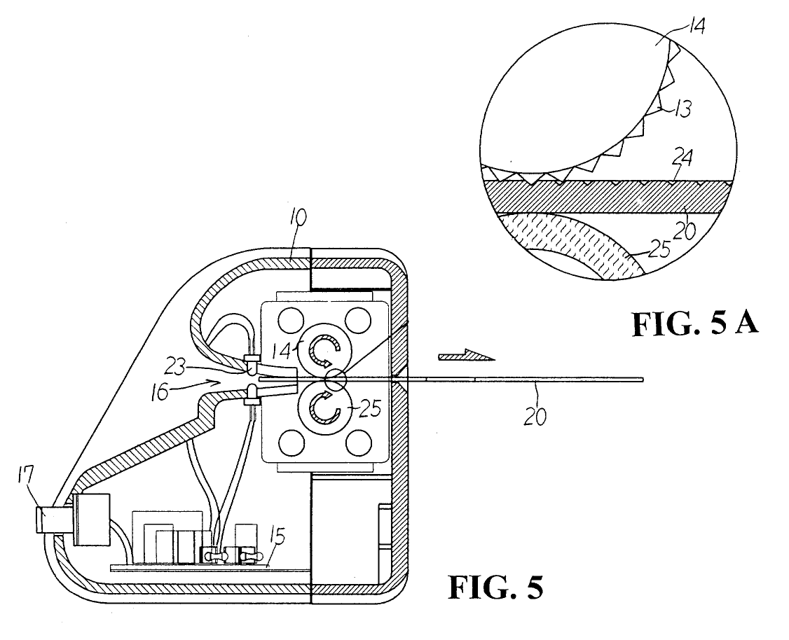

With reference to FIGS. 1 and 2, the present invention comprises a housing 10 which is composed of front and rear portions which are connected together by screws 11. Two panels 12 are mounted within the housing 10. Two metal rollers 14 and 141 are rotatably mounted between the two panels 12. The surface of the two rollers 14 and 141 is processed with hardening treatment, so as to increase the hardness of the two rollers 14 and 141. The distance between the two rollers 14 and 141 is slightly less than the thickness of an optical disc 20. The outer side of one of the panels 12 is provided with a set of gears 21 which are driven by a motor 22. The gears 21 drive the rollers 14 and 141. The motor 22 is controlled by an electrical circuit 15. The housing 10 is formed with a slot 16 for the passage of an optical disc. The electrical circuit 15 is provided with one or more sensors 23 for detecting the optical disc 20. When an optical disc 20 is inserted into the slot 16, the sensors 23 will activate the electrical circuit 15 to turn on the motor 22, thereby rotating the rollers 14, so that the optical disc 20 will be automatically moved into the frame 10 by the two rollers 14 and 141. When the optical disc 20 passes through the two rollers 14 and 141, the protuberances 13 on the surface of the two rollers 14 and 141 will form a plurality of cavities on the two sides of the optical disc 20. The shape of the protuberances 13 is not limited. This plurality of cavities prevents the optical disc 20 from being read.

For single-sided optical discs, one of the metal rollers 14 and 141 may be replaced with a rubber roller 25. Further, the switch 17 is designed so that it can control the rollers to change its direction to reverse. It should be noted, however, that this apparatus can also be used for destroying the data on credit cards, compact discs, and the like.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A machine for indenting surface of optical discs comprising:
a housing having a slot;
two panels mounted within said housing;
two rollers rotatably mounted between said two panels and provided with a plurality of protuberances thereon;
a set of gears mounted on an outer side of one of said rollers and drivingly connected with said rollers;
a motor drivingly connected with said gears;
a control circuit electrically connected with said motor; and
at least a sensor electrically connected with said control circuit and mounted close to said slot.

2. The machine for indenting surface of optical discs as claimed in claim 1, wherein one of said rollers is replaced with a rubber roller.

3. The machine for indenting surface of optical discs as claimed in claim 1, wherein said control circuit has a switch which can control said rollers to change direction to reverse.
